(19) United States
(12) Patent Application Publication
(10) Pub. No.: US 2007/0124442 A1
(43) Pub. Date: May 31, 2007

(54) Computer and control method thereof

(75) Inventor: Eun-sik Jang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/544,604

(22) Filed: Oct. 10, 2006

(30) Foreign Application Priority Data
Oct. 14, 2005 (KR) 2005-97193

(51) Int. Cl. G06F 15/173

(52) U.S. Cl. 709/223

(57) ABSTRACT

A computer and a control method thereof, includes: a connection interface to receive a communication signal having at least one of a first communication signal and a second communication signal; a communication signal sensor to sense whether the first communication signal is received through the connection interface; a communication driver to communicate with an external apparatus in accordance with whether at least one of the first communication signal and the second communication signal is received through the connection interface; a route selector to select a route in which the communication signal is applied; and a control to control the route selector so that the communication signal is applied to one of the communication signal sensor and the communication driver in accordance with whether the communication signal is received. With this configuration, wasteful power consumption in the communication driver can be reduced.

### CROSS-REFERENCE TO RELATED APPLICATION

This application claims priority from Korean Patent Application No. 2005-97193, filed on Oct. 14, 2005, in the Korean Intellectual Property Office, the disclosure of which is incorporated herein by reference.

### BACKGROUND OF THE INVENTION

1. Field of the Invention

Aspects of the present invention relate to a computer and a control method thereof, and more particularly, to a computer and a control method thereof which are capable of reducing power consumption of the computer.

2. Description of the Related Art

Computers such as a portable computer are classified into different groups, including a laptop computer, a PDA, a tablet computer, a desktop computer, and the like. The computers are widely used to not only process information, but also to transmit data to each other through a network. Lately, there has been much progress of network technologies such as Internet, and the like.

Such computers can transmit/receive the data to/from an external apparatus through the network connected via a Local Area Network (LAN) and the network connected via a Wide Area Network (WAN) by using a LAN card, a Lan on Motherboard (LOM), and the like.

To communicate, the computer outputs a link pulse signal periodically while an external apparatus such as a repeater also outputs a link pulse signal periodically when the computer is not coupled with the network. Consequently, when the computer becomes connected with the network via a given network cable, the computer may transmit/receive the link pulse signal. When the link pulse signal is transmitted normally, the computer will start to communicate by transmitting/ receiving data to/from a device such as an external computer. When communication starts, the computer and the repeater will cease outputting the respective link pulse signals. On the other hand, when the network cable becomes decoupled to the computer, the computer recognizes that transmission/reception of the data has been interrupted and resumes outputting the link pulse signal.

In a conventional computer, a communication driving unit such as a LAN card, and the like, is driven irrespective of whether the computer is coupled with the network. Specifically, when the communication driving unit is enabled even when it is not coupled with the network, it will remain in a condition in which to sense whether it is coupled with the network, output a given link pulse signal periodically, and perform a variety of functions as if it is coupled with the network. Therefore, the conventional computer allows the communication driving unit to be driven regardless of whether it is coupled with the network, which results in wasted power consumption.

### SUMMARY OF THE INVENTION

Accordingly, it is an aspect of the present invention to have a computer and a control method thereof which are capable of reducing power consumption in the communication driving unit of a computer.

The foregoing and/or other aspects of the present invention include a computer including: a connection interface unit to receive a communication signal having at least one of a first communication signal and a second communication signal; a communication signal sensing unit to sense whether the first communication signal is received through the connection interface unit; a communication driving unit to communicate with an external apparatus in accordance with whether the at least one of the first communication signal and the second communication signal is received through the connection interface unit; a route selection unit to select a route to which the communication signal is routed; and a control unit to control the route selection unit to route the communication signal having at least one of the first communication signal and the second communication signal to one of the communication signal sensing unit and the communication driving unit in accordance with whether the communication signal is received by the communication driving unit.

According to an aspect of the invention, when the communication signal is received, the control unit controls the route selection unit to route the communication signal to the communication signal sensing unit and then to route the communication signal to the communication driving unit once the first communication signal of the communication signal is sensed by the communication signal sensing unit.

According to an aspect of the invention, the control unit controls the route selection unit to change the routing of the communication signal back only to the communication signal sensing unit once the communication driving unit no longer receives the communication signal.

According to an aspect of the invention, the control unit disables the communication driving unit once the communication driving unit no longer receives the communication signal.

According to an aspect of the invention, the second communication signal of the communication signal comprises predetermined address information and data, and the communication driving unit receives the communication signal containing the second communication signal from the external apparatus, recognizes the external apparatus based on the address information of the second communication signal, and transmits/receives the data to/from the external apparatus.

Another aspect of the present invention includes a method of controlling a computer receiving a communication signal having at least one of a first communication signal and a second communication signal, the method including: preparing a communication signal sensing unit to sense whether the first communication signal is received, and a communication driving unit to communicate with an external apparatus; sensing whether the communication signal is received through at least one of the communication signal sensing unit and the communication driving unit; and applying the communication signal selectively to one of the communication signal sensing unit and the communication driving unit in accordance with whether the communication signal is received by the communication driving unit.

According to an aspect of the invention, the applying the communication signal selectively to one of the communication signal sensing unit and the communication driving unit includes: routing the communication signal to the communication signal sensing unit when the communication signal is first received; and changing the routing of the communication signal from the communication signal sensing unit to the communication driving unit once the first communication signal is sensed through the communication signal sensing unit.

According to an aspect of the invention, the method further includes: changing the routing of the communication signal back to the communication signal sensing unit when the communication driving unit no longer receives the communication signal.

According to an aspect of the invention, the method further comprises disabling the communication driving unit when the communication driving unit no longer receives the communication signal.

According to an aspect of the invention, the second communication signal of the communication signal comprises predetermined address information and data, and the communication driving unit receives the communication signal containing the second communication signal from an external apparatus, recognizes the external apparatus based on the address information of the second communication signal, and transmits/receives the data to/from the external apparatus.

According to an aspect of the invention, a device, includes: a sensor to sense a link pulse signal; a driver to sense the link pulse signal and a communication signal; and a controller to disable the driver prior to receipt of the link pulse signal by the sensor and to enable the driver after receipt of the link pulse signal by the sensor.

According to an aspect of the invention, a method of controlling a device including a sensor and a driver, includes: sensing a link pulse signal using the sensor while the driver is disabled; enabling the driver in response to the link pulse signal being sensed by the sensor; and sensing the link pulse signal and a communication signal using the driver.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 shows a perspective view of a computer according to aspects of the present invention.

FIG. 2 shows a control block diagram of the computer according to FIG. 1.

FIG. 3 shows a control flowchart of a method of controlling a communication route of a computer according to aspects of the present invention.

### DETAILED DESCRIPTION OF THE EMBODIMENTS

Reference will now be made in detail to the aspects of the present invention, examples of which are illustrated in the accompanying drawings, wherein like reference numerals refer to like elements throughout. The aspects are described below so as to explain the present invention by referring to the figures.

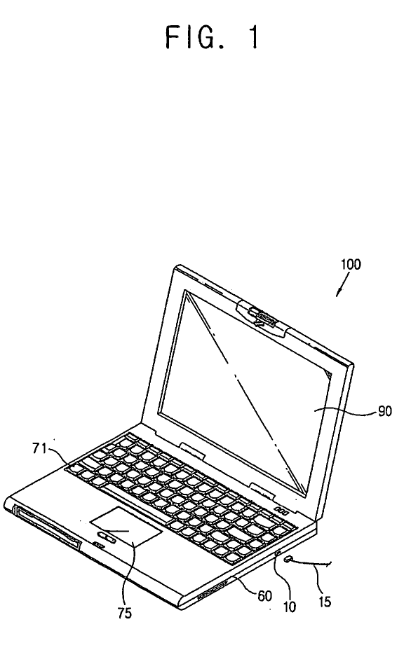

FIG. 1 shows a perspective view of a computer according to aspects of the present invention. A computer 100 according to an aspect of the present invention comprises a main body 60 in which parts such as a main board, a CPU (Central Processing Unit), and the like (not shown), are mounted, and a display unit 90 which displays an image based on a video signal inputted from the main body 60. On the top of the body 60 is a keyboard 71 composed of a plurality of input keys and a touch pad 75 used to input information in accordance with a user's manipulation. In various aspects of the present invention, any other types of input devices may be used, such as track balls, joystick, voice recognition, and the like. Such input devices may be used to input information or move a cursor.

Further, the computer 100 according to an aspect of the present invention comprises a connection interface unit 10 for transmitting/receiving a communication signal. Such a communication signal may be at least one of a first communication signal, a second communication signal, or any combination thereof. Here, the connection interface unit 10 can be coupled with the network cable 15 to transmit/receive the communication signal to/from an external apparatus 200, which may be a networking device. In various aspects of the present invention, the interface unit 10 may be a USB port, a firewire port, a Bluetooth port, and the like. Accordingly, the interface unit 10 may be any type of interface that allows for coupling with the network cable 15, or linking to a network.

Although FIG. 1 shows a portable computer in which the display unit 90 and the main body 60 are integrated by a way of an example, the computer 100 according to various aspects of the present invention can include a desktop computer in which the display unit 90 and the main body 60 are separated or integrated. The types of computers are not limited to portable or desktop computers, and may include personal digital assistants (PDA's), cell phones, game consoles, and the like. In other words, computers may include any electronic devices with computing and communicating capabilities.

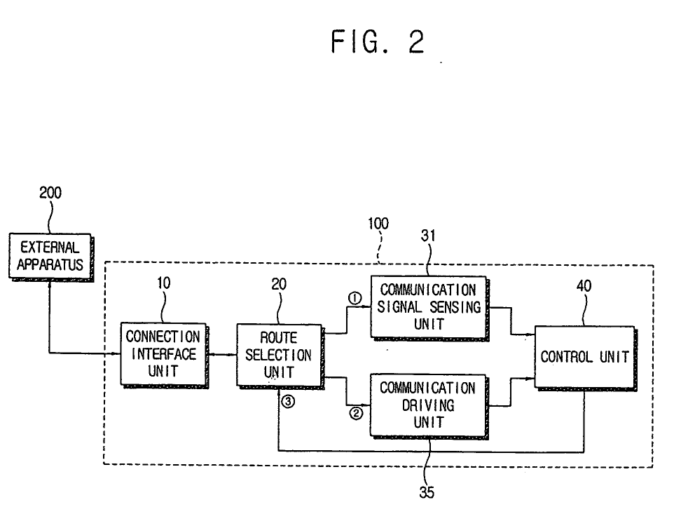

FIG. 2 shows a control block diagram of the computer according to FIG. 1. As shown in FIG. 2, the computer 100 of FIG. 1 includes the connection interface unit 10, a route selection unit 20, a communication signal sensing unit 31, a communication driving unit 35, and a control unit 40. The control unit 40 controls the various component units of the computer 100. The computer 100 further includes the display unit 90 if the computer 100 is of a type integrated with the display unit 90.

The connection interface unit 10 according to an aspect of the present invention can include a predetermined connection terminal (not shown) to transmit/receive the communication signal via the network cable 15 coupled with the connection terminal. Particularly, if the connection interface unit 10 is coupled with the network cable 15, the computer 100 according to an aspect of the present invention will receive a first communication signal periodically due to the connection of the network cable 15. That is, the connection interface unit 10 can be connected with the network via the network cable 15. Nevertheless, the computer 100 need not be only connected to the network via the network cable 15. In various aspects of the present invention, the computer 100 may be connected, or otherwise linked, to the network wirelessly. The connection interface unit 10 may be changed or eliminated accordingly.

In various aspects of the present invention, the first communication signal can include a link pulse signal to be outputted periodically from a predetermined external apparatus 200. Such an external apparatus 200 may include a repeater, a router, a base station, another computer, and the like. That is, if the network cable 15 is coupled with the connection interface unit 10, the computer 100 receives the link pulse signal periodically. When it is determined that the computer 100 is connected with the network cable 15 through the connection unit 10 to communicate with the network, the external apparatus 200 will interrupt or cease the output of the link pulse signal which has been periodically transmitted to the computer 100. When the link pulse signal output is interrupted or ceased, a second communication signal may be output by the external apparatus 200. In other aspects of the present invention, the second communication signal may be output at the same time as the first communication signal, and may be continued to be output even after the link pulse signal or the first communication signal is interrupted or ceased.

In various aspects of the present invention, the second communication signal can include various types of communication protocols, information on data, address information of transmitting/receiving units, information for error correction, and other optional information, and the like, or any combination thereof. Consequently, when the computer 100 according to aspects of the present invention determines that the first communication signal has been received and the network cable 15 is coupled with the connection interface 10, the computer 100 starts to communicate with the network by receiving the second communication signal. Further, the computer 100 starts to communicate with the predetermined external apparatus 200 based on the second communication signal.

On the other hand, the computer 100 may no longer receive the second communication signal due to a decoupling of the network cable 15. In such a case, the computer 100 would determine that the communication is interrupted. If so, a route or routing of the communication signal can be changed by the route selection unit 20 (to be described below) under control of the control unit 40 (to be described below) of the computer 100.

The route selection unit 20 selects the route of the communication signal inputted via the network cable 15. That is, the route selection unit 20 allows the communication signal inputted via the network cable 15 to be outputted to either of the communication signal sensing unit 31 (to be described below) or the communication driving unit 35 (to be described below). That is, the route selection unit 20 selects the internal route of the communication signal within the computer 100 so that the communication signal may be outputted to one of the communication signal sensing unit 31 and the communication driving unit 35 through either of a route \textcircled{0} or a route \textcircled{2} in accordance with a control signal of the control unit 40. Here, the route selection unit 20 may include a component which is capable of selecting and changing the route of the communication signal, such as a multiplexer (MUX), a switch, and the like.

In various aspects of the present invention, the communication sensing unit 31 senses whether the first communication signal, e.g., the link pulse signal is inputted, and then outputs the sensed result to the control unit 40.

In various aspects of the present invention, the communication driving unit 35 can sense whether the first communication signal is inputted, as it is with the communication signal sensing unit 31. However, unlike the communication signal sensing unit 31, which can only sense whether the first communication signal is received, the communication driving unit 35 can sense whether the second communication signal, in addition to the first communication signal, is inputted and can communicate with the external apparatus 200 by analyzing the communication signal and each of the first and second communication signals.

The communication driving unit 35 can recognize the address information of the external apparatus 200, from which the second communication signal is outputted, by analyzing the second communication signal when the communication driving unit 35 receives the communication signal. The communication driving unit 35 may communicate with the external apparatus 200 such as an external computer, a printer, and the like, based on the address information through the connection interface unit 10 by transmitting and/or receiving the data. Here, the communication driving unit 35 can include a variety of components such as the LAN card, the LOM, and the like. In various aspects of the present invention, the address information of the external apparatus 200 may include a Media Access Control address (MAC).

In various aspects of the present invention, the communication driving unit 35, which is connected with the network via the network cable 15, can transmit/receive the data to/from the external apparatus 200 through communication network technology such as Ethernet, Alohanet, Token Ring, and the like in compliance with standards adopted in an IEEE 802 committee. The communication driving unit 35 can transmit/receive the data using the connection technology such as Bluetooth, Ir-DA, Home-RF, and the like. In various aspects of the present invention, other standards are included, such as those related to wireless personal area network (WPAN) based on an IEEE 802.15.4 standard, such as ZigBee, or the like.

The control unit 40 can control the communication driving unit 35 to perform the communication, and can control the route selection unit 20 to select the internal route of the communication signal within the computer 100. Subsequently, at least one of the first communication signal and the second communication signal is applied to one of the communication signal sensing unit 31 and the communication driving unit 35.

The control unit 40 of the computer 100 according to an aspect of the present invention controls the route selection unit 20 so that an incoming communication signal is routed to route \textcircled{1} when the computer 100 was not previously receiving the communication signal. On the other hand, the control unit 40 controls the route selection unit 20 to change the routing of the communication signal into route \textcircled{2} so that the communication signal is applied to the communication driving unit 35 when the communication signal sensing unit 31 senses that the first communication signal is received. Subsequently, the control unit 40 controls the route selection unit 20 to change the routing of the communication signal back into route \textcircled{1} when the computer 100 does not receive at least one of the first communication signal and the second communication signal.

More specifically, the control unit 40 can control the route selection unit 20 to change the routing of the communication signal into route \textcircled{2} and enable the communication driving unit 35 when the computer 100 receives the communication signal through the communication signal sensing unit 31. In such a case, the received communication signal is inputted to the communication driving unit 35. The communication driving unit 35 can determine whether the network cable 15 is presently coupled with the connection interface unit 10 by analyzing the input communication signal, and then begin communication when the network cable 15 is presently connected with the connection interface unit 10.

On the other hand, when the communication driving unit 35 senses that the first communication signal and the second communication signal are not received when the route of the communication signal is selected as route \textcircled{2} during reception of the communication signal, the control unit 40 controls the route selection unit 20 to change the route of the communication signal back into route \textcircled{2}. Further, the control unit 40 disables the communication driving unit 35. Consequently, the computer 100 according to aspects of the present invention allows the communication driving unit 35 to be disabled (or turned off, or not have current or voltage supplied thereto) when the communication signal is not received. In other words, the communication driving unit 35 is purposely disabled when the connection interface unit 10 is not connected with the network cable 15 to reduce the wasteful consumption of power by the communication driving unit 35.

Thus, unlike the conventional communication driving unit that is always enabled (or turned on, or have current or voltage supplied thereto) to periodically output the first communication signal, the computer 100 according to an aspect of the present invention disables the communication driving unit 35 when the communication signal is not received. Thus, the communication driving unit 35 does not output its own first communication signal (e.g., link pulse signal), which results in reduced power consumption.

Although not required in all aspects, when the route selection unit 20 according to aspects of the present invention is a multiplexer (MUX), the control unit 40 can output the control signal for controlling the routing function of the route selection unit 20 through a predetermined select line (e.g., a route \textcircled{3}).

For example, when the control unit 40 determines that the communication signal is received, a logic value of “1” is outputted to the route selection unit 20 via the select line. Then, the route selection unit 20 can select route \textcircled{2}. On the other hand, when the control unit 40 determines that the communication signal is not received, a logic value of “0” is outputted to the route selection unit 20 via the select line. Then, the route selection unit 20 can select route \textcircled{1}. In various aspects of the present invention, the output of the MUX according to the logic value received through the select line may be changed in accordance with the design of the MUX. Alternatively, the output of the MUX according to the logic value may be inversed so that the logic value of “1” would cause the selection of route \textcircled{1} and the logic value of “0” would cause the selection of route \textcircled{2}.

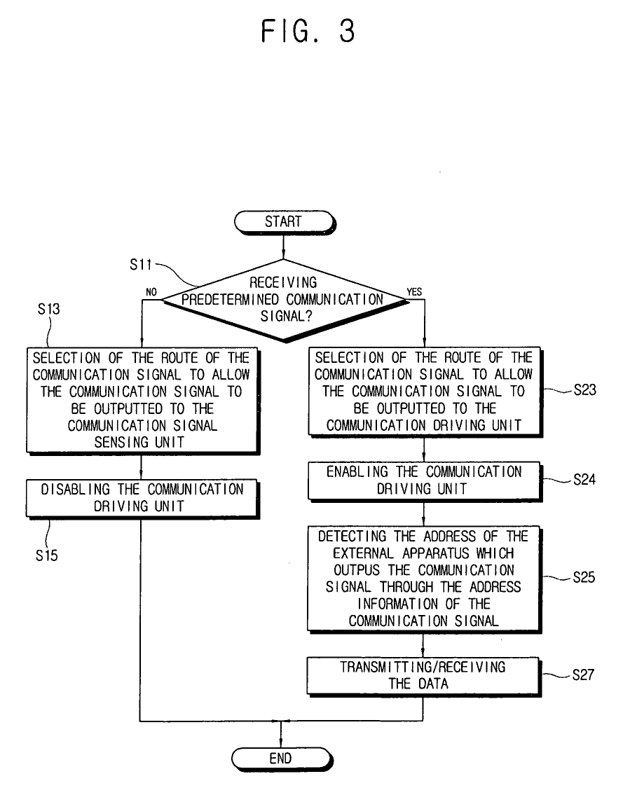

FIG. 3 shows a control flow of a method of controlling a communication route of a computer according to aspects of the present invention. The computer 100 of FIGS. 1 and 2 may be used to implement the control flow of FIG. 3, but such use of the computer 100 is not required.

As shown in FIG. 3, the computer 100 according to an aspect of the present invention determines whether the connection interface unit 10 is connected with the network cable 15 to receive the communication signal with at least one of the first communication signal and the second communication signal, in operation S11. Here, the first communication signal includes the link pulse signal outputted from the external apparatus 200 such as the repeater and the like, and is applied to the computer 100 through the connection interface unit 10 periodically when the network cable 15 is connected with the connection interface unit 10.

When either of the communication signal sensing unit 31 or the communication driving unit 35 senses that the communication signal is received via the network cable 15 (yes in operation S11), the control unit 40 controls the route selection unit 20 to route the communication signal to the communication driving unit 35 via route \textcircled{2}, in operation S23, and the control unit 40 enables the communication driving unit 35, in operation S24.

When the communication signal is received, the enabled communication driving unit 35 detects the address of the external apparatus 200 by detecting the address information of the communication signal, in operation S25, and starts to communicate with the detected external apparatus 200 to transmit/receive the data, in operation S27. Thereafter, the operation ends.

On the other hand, when either of the communication signal sensing unit 31 or the communication driving unit 35 does not receive the communication signal (no in operation S11), the control unit 40 controls the route selection unit 20 to route the communication signal to the communication signal sensing unit 31 through route \textcircled{1} in operation S13, and disables the communication driving unit 35, in operation S15. Thereafter, the operation ends.

Accordingly, various devices, such as computers, are capable of reducing power consumption by disabling a communication driving unit of the devices, such that supply of power from batteries of portable devices are prolonged, and consumption of standby power from power outlets of plugged in devices are reduced.

In the various aspects of the present invention described earlier, the control unit 40 can include at least one of a microcomputer, a CPU, an OS, and the like. For example, in the case of the control unit 40 with the microcomputer and the OS, when the OS delivers a signal for enabling/disabling the communication driving unit 35 to the microcomputer in accordance with the sensed results of the communication signal from the communication signal sensing unit 31 and the communication driving unit 35, the microcomputer can enable/disable the communication driving unit 35 according to the communication signal. It will be appreciated that each operation of the control unit 40 with the microcomputer and the OS is not limited to the above descriptions disclosed, but is only an optional aspect.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A computer comprising:
a connection interface unit to receive a communication signal having at least one of a first communication signal and a second communication signal;
a communication signal sensing unit to sense whether the first communication signal is received through the connection interface unit;
a communication driving unit to communicate with an external apparatus in accordance with whether the at least one of the first communication signal and the second communication signal is received through the connection interface unit;
a route selection unit to select a route to which the communication signal is routed; and
a control unit to control the route selection unit to route the communication signal having the at least one of the first communication signal and the second communication signal to one of the communication signal sensing unit and the communication driving unit in accordance with the communication signal.

2. The computer according to claim 1, wherein when the communication signal is received, the control unit controls the route selection unit to route the communication signal to the communication signal sensing unit and then to route the communication signal to the communication driving unit once the first communication signal of the communication signal is sensed by the communication signal sensing unit.

3. The computer according to claim 2, wherein the control unit controls the route selection unit to change the routing of the communication signal back only to the communication signal sensing unit once the communication driving unit no longer receives the communication signal.

4. The computer according to claim 3, wherein the control unit disables the communication driving unit once the communication driving unit no longer receives the communication signal.

5. The computer according to claim 4, wherein the second communication signal of the communication signal comprises predetermined address information and data, and
the communication driving unit receives the communication signal containing the second communication signal from the external apparatus, recognizes the external apparatus based on the address information of the second communication signal, and transmits/receives the data to/from the external apparatus.

6. A method of controlling a computer receiving a communication signal having at least one of a first communication signal and a second communication signal, the method comprising:
preparing a communication signal sensing unit to sense whether the first communication signal is received, and a communication driving unit to communicate with an external apparatus;
sensing whether the communication signal is received through at least one of the communication signal sensing unit and the communication driving unit; and
applying the communication signal selectively to one of the communication signal sensing unit and the communication driving unit in accordance with whether the communication signal is received by the communication driving unit.

7. The method according to claim 6, wherein the applying the communication signal selectively to one of the communication signal sensing unit and the communication driving unit comprises:
routing the communication signal to the communication signal sensing unit when the communication signal is first received; and
changing the routing of the communication signal from the communication signal sensing unit to the communication driving unit once the first communication signal is sensed through the communication signal sensing unit.

8. The method according to claim 7, further comprising,
changing the routing of the communication signal back to the communication signal sensing unit when the communication driving unit no longer receives the communication signal.

9. The method according to claim 8, further comprising disabling the communication driving unit when the communication driving unit no longer receives the communication signal.

10. The method according to claim 9, wherein the second communication signal of the communication signal comprises predetermined address information and data, and
the communication driving unit receives the communication signal containing the second communication signal from an external apparatus, recognizes the external apparatus based on the address information of the second communication signal, and transmits/receives the data to/from the external apparatus.

11. The computer according to claim 1, wherein the second communication signal includes at least one of a communication protocol, information on data, address information of transmitting and/or receiving units, and information for error correction.

12. A device, comprising:
a sensor to sense a link pulse signal;
a driver to sense the link pulse signal and a communication signal; and
a controller to disable the driver prior to receipt of the link pulse signal by the sensor and to enable the driver after receipt of the link pulse signal by the sensor.

13. The device of claim 12, wherein the driver is disabled when the link pulse signal and the communication signal are not sensed by the driver.

14. The device of claim 12, wherein the driver is disabled by not being supplied with power.

15. The device of claim 12, wherein the driver communicates with an external device when the communication signal is sensed by the driver.

16. The device of claim 12, wherein the communication signal comprises at least one of a communication protocol, information on data, address information of transmitting and/or receiving units, and information for error correction.

17. The device of claim 12, wherein the driver is disabled when the sensor does not sense the link pulse signal and the driver does not sense the link pulse signal and the communication signal.

18. The device of claim 12, wherein the device is a portable computer.

19. A method of controlling a device including a sensor and a driver, comprising:
sensing a link pulse signal using the sensor while the driver is disabled;
enabling the driver in response to the link pulse signal being sensed by the sensor; and
sensing the link pulse signal and a communication signal using the driver.

20. The method according to claim 19, further comprising disabling the driver when the link pulse signal and the communication signal are not sensed by the driver.

21. The method according to claim 19, wherein the driver is disabled by not being supplied with power.

22. The method according to claim 19, further comprising communicating with an external device when the communication signal is sensed by the driver.

23. The method according to claim 19, wherein the communication signal comprises at least one of a communication protocol, information on data, address information of transmitting and/or receiving units, and information for error correction.

24. The method according to claim 19, further comprising disabling the driver when the sensor does not sense the link pulse signal and the driver does not sense the link pulse signal and the communication signal.
